(19) United States
(12) Patent Application Publication
(10) Pub. No.: US 2013/0223866 A1
(43) Pub. Date: Aug. 29, 2013

(54) PRINTING SYSTEM, IMAGE INSPECTING APPARATUS, AND PRINTING METHOD

(71) Applicants: Toshiyuki KAZAMA, Kanagawa (JP); Kenji HYOKI, Kanagawa (JP); Masaki FUJISE, Kanagawa (JP)

(72) Inventors: Toshiyuki KAZAMA, Kanagawa (JP); Kenji HYOKI, Kanagawa (JP); Masaki FUJISE, Kanagawa (JP)

(73) Assignee: FUJI XEROX CO., LTD., Tokyo (JP)

(21) Appl. No.: 13/566,747

(22) Filed: Aug. 3, 2012

(30) Foreign Application Priority Data
Feb. 23, 2012 (JP) 2012-037253

(51) Int. Cl. G03G 15/00

(52) U.S. Cl. 399/82

(57) ABSTRACT

A printing system includes following components. A deciding unit decides, by using setting data and output image data including pieces of original image data corresponding to plural pages, a printing order in which the plural pages are to be printed. A printing unit respectively prints images of the plural pages on recording media by using the output image data, in accordance with the printing order. A reading unit reads, in accordance with the printing order, the images of the plural pages having been printed on the recording media to obtain pieces of read image data corresponding to the plural pages. An identifying unit identifies pieces of reference image data corresponding to the plural pages of the output image data, in accordance with the printing order. A verification unit verifies, for each page, the piece of read image data of the page against the corresponding piece of reference image data.

### CROSS-REFERENCE TO RELATED APPLICATIONS

This application is based on and claims priority under 35 USC 119 from Japanese Patent Application No. 2012-037253 filed Feb. 23, 2012.

### BACKGROUND

(i) Technical Field

The present invention relates to a printing system, an image inspecting apparatus, and a printing method.

### SUMMARY

According to an aspect of the invention, there is provided a printing system including a deciding unit, a printing unit, a reading unit, an identifying unit, and a verification unit. The deciding unit decides, by using output image data that includes pieces of original image data corresponding to plural pages and by using setting data associated with the output image data, a printing order in which the plural pages of the output image data are to be printed. The printing unit respectively prints images of the plural pages on recording media by using the output image data, in accordance with the printing order decided by the deciding unit. The reading unit reads, in accordance with the printing order decided by the deciding unit, the images of the plural pages having been printed by the printing unit on the recording media to obtain pieces of read image data corresponding to the plural pages. The identifying unit identifies pieces of reference image data corresponding to the plural pages of the output image data, in accordance with the printing order decided by the deciding unit. The verification unit verifies, for each page, the piece of read image data of the page against the corresponding piece of reference image data identified by the identifying unit.

### BRIEF DESCRIPTION OF THE DRAWINGS

Exemplary embodiments of the present invention will be described in detail based on the following figures, wherein:

FIG. 1 illustrates a configuration of a printing system;

FIG. 2 illustrates a configuration of a printer;

FIG. 3 is a block diagram illustrating a functional configuration of a setting apparatus;

FIG. 4 is a block diagram illustrating a functional configuration of the printer;

FIG. 5 is a block diagram illustrating a functional configuration of an inspecting apparatus;

FIG. 6 is a sequence diagram for describing an operation of the printing system according to a first exemplary embodiment;

FIGS. 7A to 7C describe job scheduling;

FIGS. 8A and 8B describe the inspection order when a method according to the first exemplary embodiment is used and the inspection order when a method according to the related art is used;

FIG. 9 is a sequence diagram for describing an operation of the printing system according to a second exemplary embodiment;

FIG. 10 is a sequence diagram for describing an operation of the printing system according to a third exemplary embodiment;

FIG. 11 is a sequence diagram for describing an operation of the printing system according to a fourth exemplary embodiment;

FIG. 12 is a block diagram illustrating a functional configuration of the inspecting apparatus according to a fifth exemplary embodiment; and

FIG. 13 is a sequence diagram for describing an operation of the printing system according to the fifth exemplary embodiment.

### DETAILED DESCRIPTION

Exemplary embodiments of the present invention will be described in detail below with reference to the accompanying drawings.

### First Exemplary Embodiment

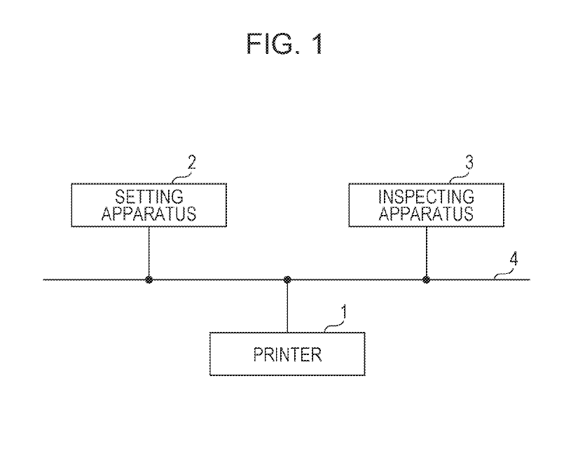

FIG. 1 illustrates a configuration of a printing system to which this exemplary embodiment is applied.

The printing system according to this exemplary embodiment includes a printer 1 that prints an image on a sheet of paper, a setting apparatus 2 that sets image data (output image data) to be printed in the printer 1 and sets a condition of printing (print setting data), an inspecting apparatus 3 that inspects content of an image (printed image) having been printed on a sheet of paper by the printer 1, and a network 4 that interconnects the printer 1, the setting apparatus 2, and the inspecting apparatus 3.

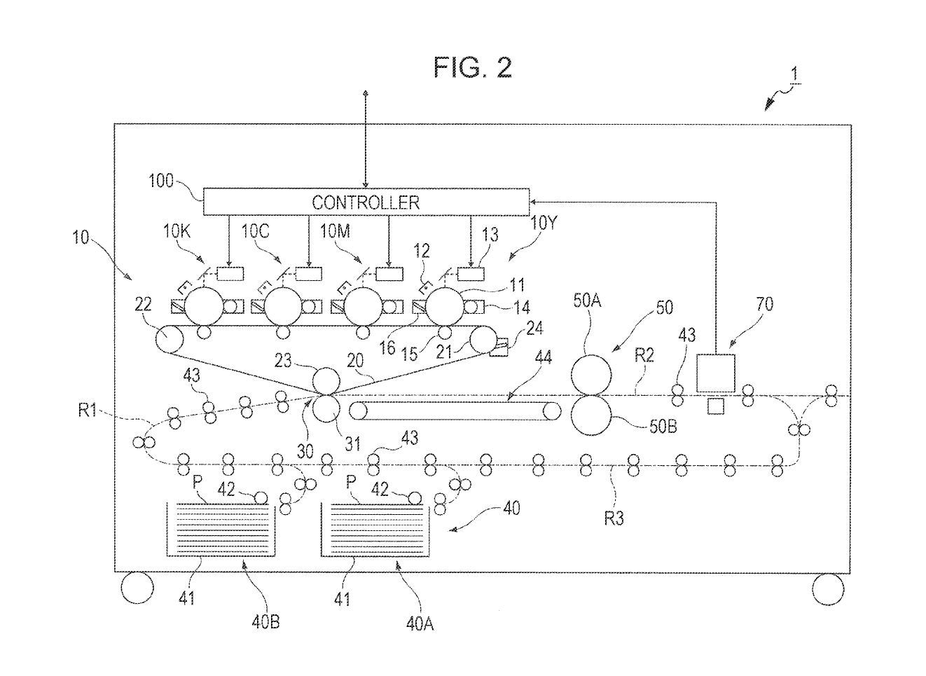

FIG. 2 illustrates a configuration of the printer 1. The printer 1 according to this exemplary embodiment is a plateless printer that prints an image by using the electrophotography.

This printer 1 has a so-called tandem configuration, and includes multiple image forming units 10Y, 10M, 10C, and 10K that form toner images of corresponding color components by using the electrophotography. The printer 1 also includes a controller 100, which includes a central processing unit (CPU), a read only memory (ROM), and a random access memory (RAM), and which controls operations (including image processing) of devices and sections of the printer 1. Here, the image forming units 10Y, 10M, 10C, and 10K form yellow, magenta, cyan, and black images, respectively.

The printer 1 also includes an intermediate transfer belt 20 onto which the toner images of the corresponding color components having been formed by the image forming units 10Y, 10M, 10C, and 10K are sequentially transferred (first transfer) and which holds the transferred toner images, and a second transfer device 30 which collectively transfers (second transfer) the toner images held on the intermediate transfer belt 20 onto paper P, which is an example of a rectangular recording medium.

Each of the image forming units 10Y, 10M, 10C, and 10K includes a rotatable photoconductor drum 11. Around the photoconductor drum 11 in each of the image forming units 10Y, 10M, 10C, and 10K, there are disposed a charging device 12 that charges the photoconductor drum 11, an exposure device 13 that exposes the photoconductor drum 11 to light so as to write an electrostatic latent image on the photoconductor drum 11, and a developing device 14 that visualizes the electrostatic latent image on the photoconductor drum 11 by using toner of the corresponding color. Furthermore, each of the image forming units 10Y, 10M, 10C, and 10K includes a first transfer device 15 that transfers the toner image of the corresponding color component having been formed on the photoconductor drum 11 onto the intermediate transfer belt 20, and a drum cleaning device 16 that removes the remaining toner from the photoconductor drum 11.

The intermediate transfer belt 20 is stretched around three rotatable rollers 21 to 23 so as to rotate therearound. Among these three rollers 21 to 23, the roller 22 drives the intermediate transfer belt 20. The roller 23 is arranged so as to face a second transfer roller 31 with the intermediate transfer belt 20 disposed therebetween. The second transfer roller 31 and the roller 23 constitute the second transfer device 30. A belt cleaning device 24 that removes the remaining toner from the intermediate transfer belt 20 is disposed at a position where the belt cleaning device 24 faces the roller 21 with the intermediate transfer belt 20 disposed therebetween.

The printer 1 has a first transport route R1 along which paper P transported toward the second transfer device 30 passes, a second transport route R2 along which the paper P having passed the second transfer device 30 passes, and a third transport route R3 that splits from the second transport route R2 on the downstream side of a fixing device (to be described later) and extends to the bottom part of the first transport route R1 so as to lead the paper P to the first transport route R1 again. Pieces of paper P that are not led to the third transport route R3, among those having been transported along the second transport route R2, are discharged to the outside of the printer 1 and are stacked on a paper tray, not illustrated.

The printer 1 also includes a paper transporting section 40 that transports the paper P along the first transport route R1, the second transport route R2, and the third transport route R3. This paper transporting section 40 includes a first paper feeding device 40A that feeds the paper P to the first transport route R1, and a second paper feeding device 40B that is disposed on the downstream side of the first paper feeding device 40A in the transport direction of the paper P and that feeds the paper P to the first transport route R1. The first paper feeding device 40A and the second paper feeding device 40B have substantially the same structure. Specifically, each of the first paper feeding device 40A and the second paper feeding device 40B includes a paper storage unit 41 that stores the paper P, and a pickup roller 42 that picks up and transports the paper P stored in the paper storage unit 41. The paper P of different sizes and orientations or of different types may be stored in the first paper feeding device 40A and the second paper feeding device 40B.

The paper transporting section 40 further includes plural transporting rollers 43 that transport the paper P while holding the paper P therebetween, along the first transport route R1, the second transport route R2, and the third transport route R3. The paper transporting section 40 also includes, along the second transport route R2, a belt transporting unit 44 that transports the paper P having passed the second transfer device 30 toward the fixing device 50.

The printer 1 further includes, along the second transport route R2, the fixing device 50 that fixes on the paper P an image having been transferred onto the paper P by the second transfer device 30. This fixing device 50 includes a heat roller 50A that is heated by a built-in heater (not illustrated), and a pressing roller 50B that presses the heat roller 50A. The paper P passes between the heat roller 50A and the pressing roller 50B, whereby the paper P is heated and pressed, and consequently the image on the paper P is fixed on the paper P in this fixing device 50.

In the following description, the image forming units 10Y, 10M, 10C, and 10K, the intermediate transfer belt 20, the second transfer device 30, the paper transporting section 40, and the fixing device 50 that have been described above are collectively referred to as an image forming section 10. The image forming section 10 according to this exemplary embodiment has functions of a printing unit, for example.

The printer 1 according to this exemplary embodiment is capable of printing images not only on a first side of the paper P fed from the first paper feeding device 40A or the like but also on a second side of the paper P. More specifically, in this printer 1, the paper P having passed the fixing device 50 after transferring of an image on the first side of the paper P is transported along the third transport route R3, whereby the paper P is turned over and the turned over paper P is fed again to the second transfer device 30. An image is then transferred onto the second side of the paper P by the second transfer device 30. Subsequently, the paper P again passes through the fixing device 50, in which the transferred image is fixed on the paper P. In this manner, images are formed not only on the first side but also on the second side of the paper P.

In addition, the printer 1 according to this exemplary embodiment includes an image reading section 70 that reads an image having been printed on the paper P through the second transfer and fixing processes. The image reading section 70 is disposed along the second transport route R2 on the downstream side of the fixing device 50 and on the upstream side of the splitting point of the second transport route R2 and the third transport route R3 in the transport direction of the paper P. The image reading section 70, i.e., an example of a reading unit, reads an image on a side of the paper P that has faced the intermediate transfer belt 20 among the sides of the paper P having passed the second transfer device 30, i.e., an image on the side of the paper P having undergone the last second transfer. Here, the image reading section 70 includes line sensors, which are arranged, for example, in the direction intersecting the transport direction of the paper P and which read one side of the transported paper P on a line-by-line basis. However, the image reading section 70 is not limited to this configuration and may include a two-dimensional area sensor.

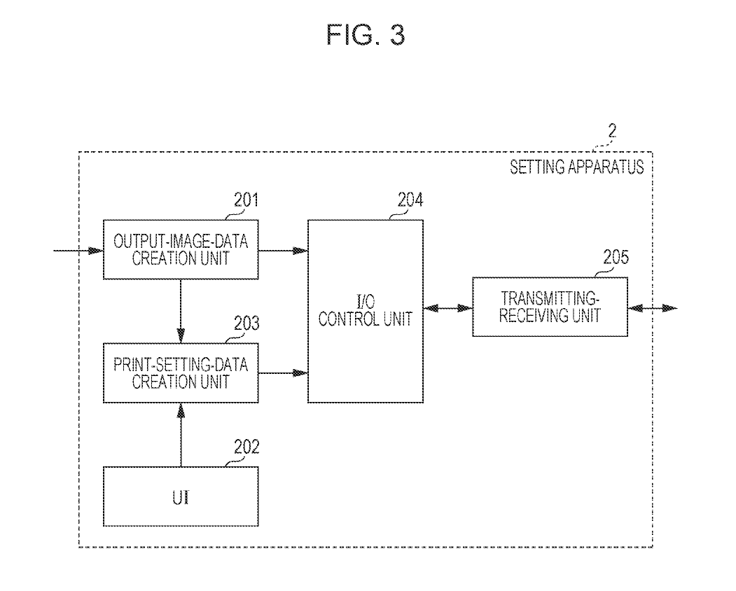

FIG. 3 is a block diagram illustrating a functional configuration of the setting apparatus 2 illustrated in FIG. 1. The setting apparatus 2 according to this exemplary embodiment is constituted by a computer that includes a CPU, a ROM, and a RAM. Here, the setting apparatus 2 is a section called digital front end (DFE) that performs data processing for inputting data to the printer 1 when a job for continuously printing images on one or more pieces of paper P is executed in response to one instruction.

This setting apparatus 2 includes an output-image-data creation unit 201, a user interface (UI) 202, a print-setting-data creation unit 203, an input-output (IO) control unit 204, and a transmitting-receiving unit 205.

For example, on the basis of image data input from the outside, the output-image-data creation unit 201 creates output image data that is interpretable by the printer 1. Here, the output image data includes plural pieces of original image data that correspond to plural pages, for example. The order, i.e., the order of page number is set for the pieces of original image data in the output image data. In the following description, plural pieces of original image data included one piece of output image data are referred to as a set of pieces of original image data. During creation of the output image data, the output-image-data creation unit 201 also acquires the number of pages of a set (the number of pieces of original image data) included in the output image data.

The UI 202 accepts input of various settings for printing before the printer 1 performs printing on the basis of the output image data. Here, examples of the settings accepted via the UI 202 include “the number of copies” for setting the number of copies to be printed, “the single-sided/double-sided setting” for setting single-sided printing in which images are printed only on a first side of paper P or double-sided printing in which images are printed on first and second sides of the paper P, and “the set-by-set/page-by-page setting (collation-enable/disable setting)” for setting set-by-set printing in which images are printed on paper P on a set-by-set basis or page-by-page printing in which images are printed on paper P on a page-by-page basis when multiple sets are to be printed. In addition to these settings, settings regarding paper P used in printing and settings regarding productivity of the printer 1 are also included. In this example, the settings regarding paper P include the size of the paper P, the orientation of the paper P, the unit weight of the paper P, and the type of the paper P (e.g., ordinary paper, coated paper, or embossed paper). Also in this example, the settings regarding the productivity of the printer 1 include “a normal mode” in which the image quality and the productivity are emphasized, and “a high-productivity mode” in which the productivity is more emphasized than the image quality by increasing the printing speed compared with the speed in the normal mode.

The print-setting-data creation unit 203 creates print setting data (setting data) used in printing of subject output image data, by using the number of pages of a set included in the output image data that is acquired from the output-image-data creation unit 201 and various settings that are acquired from the UI 202.

The I/O control unit 204 temporarily stores the output image data created by the output-image-data creation unit 201 and the print setting data created by the print-setting-data creation unit 203. The I/O control unit 204 also outputs the output image data and the print setting data in response to a request or the like input via the transmitting-receiving unit 205. In the following description, the output image data and the print setting data corresponding to this output image data are collectively referred to as job data.

The transmitting-receiving unit 205 transmits and receives various kinds of data to and from the printer 1 and the inspecting apparatus 3 illustrated in FIG. 1 via the network 4.

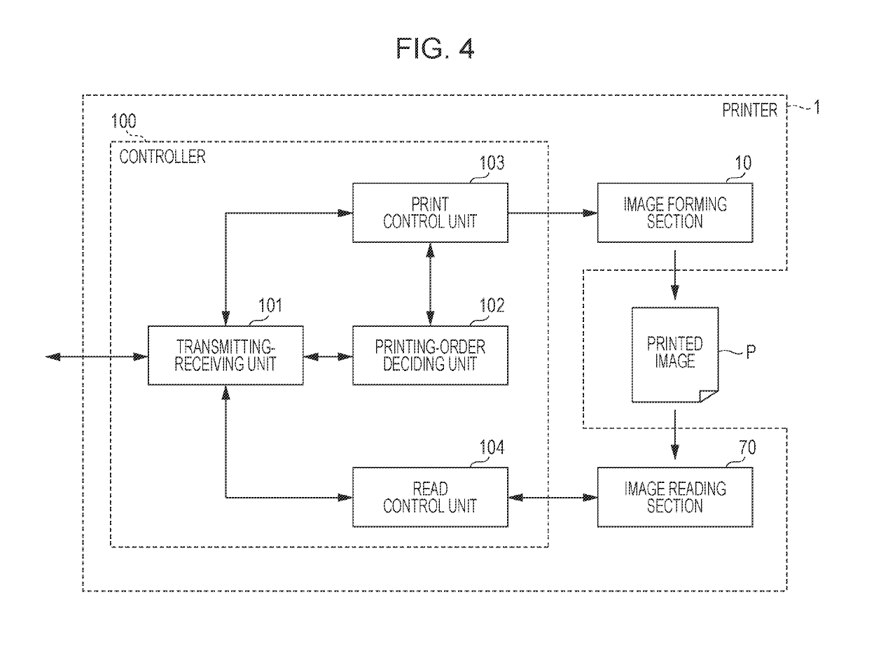

FIG. 4 is a block diagram illustrating a functional configuration of the printer 1 illustrated in FIGS. 1 and 2.

As described above, this printer 1 includes the image forming section 10 that prints an image on paper P, the image reading section 70 that reads a printed image formed on paper P, and the controller 100 that controls the image forming section 10 and the image reading section 70. In addition, the controller 100 includes a transmitting-receiving unit 101, a printing-order deciding unit 102, a print control unit 103, and a read control unit 104.

The transmitting-receiving unit 101 transmits and receives various kinds of data to and from the setting apparatus 2 and the inspecting apparatus 3 illustrated in FIG. 1 via the network 4.

The printing-order deciding unit 102, i.e., an example of a deciding unit, decides the printing order (creates scheduling data) for a job, on the basis of the print setting data input from the setting apparatus 2 via the transmitting-receiving unit 101.

The print control unit 103 controls operations of the image forming section 10, on the basis of the output image data input from the setting apparatus 2 via the transmitting-receiving unit 101 and the scheduling data input from the printing-order deciding unit 102. The print control unit 103 also interprets the output image data, thereby creating print data handled by the image forming section 10. Here, the print data includes plural pieces of exposure data (pieces of data for driving the exposure devices 13), the number of which is equal to the product of the number of pieces of original image data that constitute the output image data (the number of pages of one set) and the number of copies to be printed.

The read control unit 104 controls operations of the image reading section 70. The read control unit 104 also performs image processing, such as analog-to-digital (A/D) conversion, on analog raw data obtained by reading a printed image on paper P, thereby creating digital read image data. The read control unit 104 creates read image data for each image having been printed on one side of paper P by the image forming section 10, i.e., on a page-by-page basis.

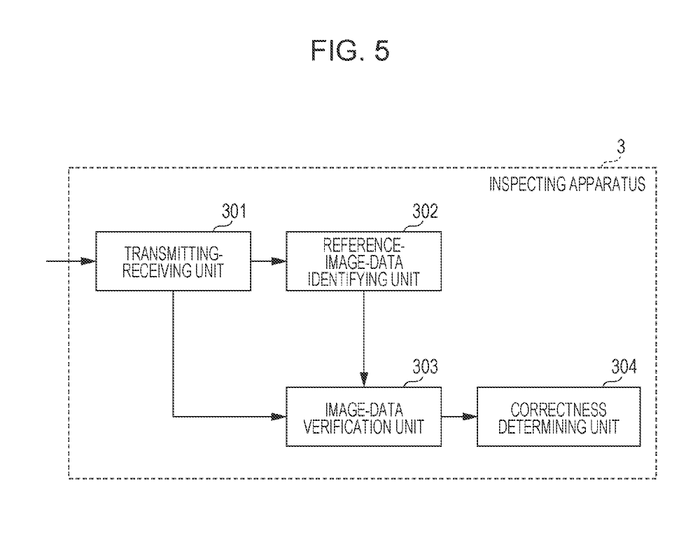

FIG. 5 is a block diagram illustrating a functional configuration of the inspecting apparatus 3 illustrated in FIG. 1. The inspecting apparatus 3 according to this exemplary embodiment is constituted by a computer that includes a CPU, a ROM, and a RAM. This inspecting apparatus 3 inspects an image having been printed on the paper P by the printer 1 for a defect, on a page-by-page basis and in accordance with the printing order.

The inspecting apparatus 3 includes a transmitting-receiving unit 301, a reference-image-data identifying unit 302, an image-data verification unit 303, and a correctness determining unit 304.

The transmitting-receiving unit 301, i.e., examples of an output-image-data acquiring unit and a printing-order acquiring unit, transmits and receives various kinds of data to and from the printer 1 and the setting apparatus 2 illustrated in FIG. 1 via the network 4.

The reference-image-data identifying unit 302, i.e., an example of an identifying unit, identifies reference image data serving as a reference in verification-based inspection performed by the image-data verification unit 303, on the basis of the output image data input from the setting apparatus 2 via the transmitting-receiving unit 301 and the scheduling data input from the printer 1 via the transmitting-receiving unit 301. More specifically, the reference-image-data identifying unit 302 identifies original image data for one page on the basis of the scheduling data, from among plural pieces of original image data that constitute the output image data, and sets the identified original image data for one page as the reference image data. The reference image data corresponding to the original image data may be created by performing image processing, such as color conversion and resolution conversion, on the identified original image data, if necessary.

The image-data verification unit 303, i.e., an example of a verification unit, compares, for verification, read image data input via the transmitting-receiving unit 301 with the reference image data identified by the reference-image-data identifying unit 302. Here, both the read image data and the reference image data that are verified by the image-data verification unit 303 are defined in the same color space.

On the basis of a result of the comparison and verification performed by the image-data verification unit 303, the correctness determining unit 304 determines whether or not an image on the paper P, from which the read image data is obtained, is correct (whether or not there is a defect in the image).

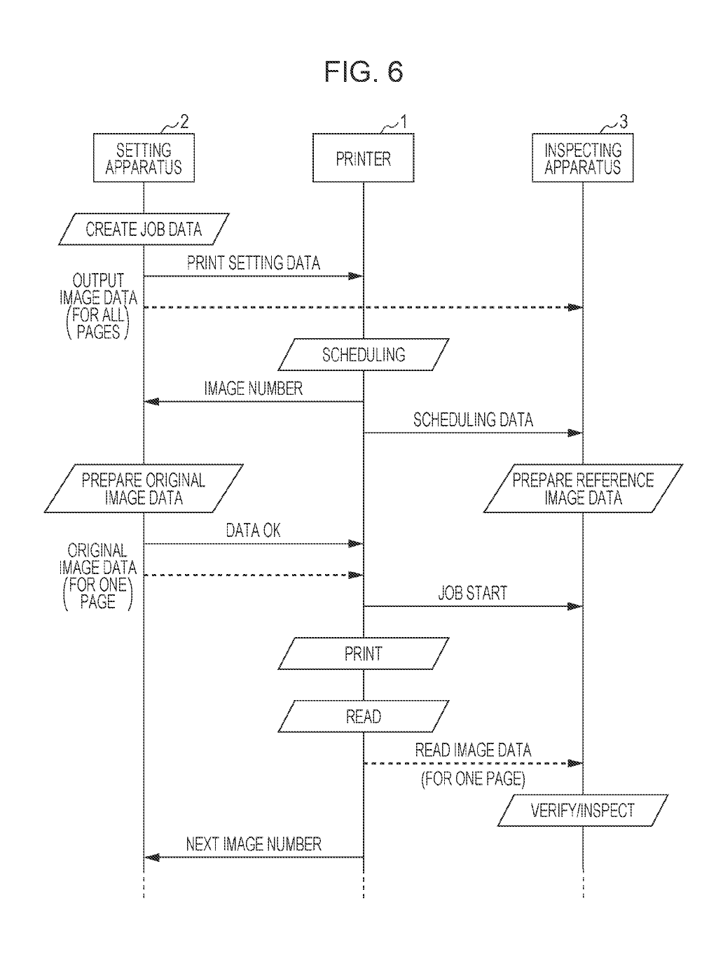

FIG. 6 is a sequence diagram for describing an operation of the printing system in the first exemplary embodiment. Operations of the apparatuses of the printing system and data exchanged between the apparatuses will be described below in accordance with FIG. 6.

Upon receipt of a job execution instruction via the UI 202 or the like, the setting apparatus 2 first creates job data.

Specifically, in creation of the job data, the output-image-data creation unit 201 of the setting apparatus 2 creates output image data (for all pages) on the basis of input image data. In the output image data, each piece of original image data is associated with an image number (a page number), the image numbers being assigned in order of page number. Also, the print-setting-data creation unit 203 of the setting apparatus 2 creates print setting data on the basis of the output image data (for all pages) and various settings. Then, the I/O control unit 204 of the setting apparatus 2 temporarily stores the job data, i.e., the output image data (for all pages) and the print setting data.

Subsequently, the setting apparatus 2 transmits the print setting data stored in the I/O control unit 204 to the printer 1. In the printer 1, the printing-order deciding unit 102 receives the print setting data.

The setting apparatus 2 further transmits the output image data (for all pages) stored in the I/O control unit 204 to the inspecting apparatus 3. In the inspecting apparatus 3, the reference-image-data identifying unit 302 receives the output image data (for all pages).

Subsequently, the printing-order deciding unit 102 of the printer 1 creates scheduling data for the job on the basis of the received print setting data. Here, in the scheduling data, the print number indicating the printing order and the image number attached to the original image data are associated with each other in time series.

Then, on the basis of the scheduling data created by the printing-order deciding unit 102, the print control unit 103 of the printer 1 transmits the image number associated with the print number to be subjected to the next printing to the setting apparatus 2. In the setting apparatus 2, the I/O control unit 204 receives the image number.

The print control unit 103 of the printer 1 also transmits the scheduling data created by the printing-order deciding unit 102 to the inspecting apparatus 3. In the inspecting apparatus 3, the reference-image-data identifying unit 302 receives the scheduling data.

Then, the I/O control unit 204 of the setting apparatus 2 prepares the original image data (for one page) corresponding to the received image number, from the output image data (for all pages) stored therein.

On the other hand, the reference-image-data identifying unit 302 of the inspecting apparatus 3 prepares (identifies) reference image data (for one page) corresponding to the original image data (for one page) to be printed next, on the basis of the already received output image data (for all pages) and the newly received scheduling data.

Subsequently, the I/O control unit 204 of the setting apparatus 2 transmits a notification (Data OK) indicating that preparation of the original image data (for one page) has been completed, to the printer 1. In the printer 1, the print control unit 103 receives this notification.

The I/O control unit 204 of the setting apparatus 2 then transmits the prepared original image data (for one page) to the printer 1. In the printer 1, the print control unit 103 receives this original image data (for one page).

Subsequently, the print control unit 103 of the printer 1 transmits a notification (Job Start) indicating that a job is about to be started, to the inspecting apparatus 3. In the inspecting apparatus 3, the image-data verification unit 303 receives this notification.

Thereafter, the image forming section 10 of the printer 1 creates exposure data based on the received original image data, and prints an image corresponding to the original image data on paper P.

Subsequently, the image reading section 70 of the printer 1 reads the image having been printed by the image forming section 10. In response to the reading, the read control unit 104 of the printer 1 creates read image data (for one page).

Then, the read control unit 104 of the printer 1 transmits the created read image data (for one page) to the inspecting apparatus 3. The image-data verification unit 303 of the inspecting apparatus 3 receives this read image data (for one page).

Subsequently, the image-data verification unit 303 of the inspecting apparatus 3 verifies the read image data (for one page) transmitted from the printer 1 against the reference image data (for one page) identified by the reference-image-data identifying unit 302. Here, the reference image data (for one page) and the read image data (for one page) verified at this time are obtained from the original image data of the same page that constitutes the output image data. The correctness determining unit 304 of the inspecting apparatus 3 then determines whether or not the printed material serving as the original of the read image data is correct (whether or not there is a defect in the image), on the basis of a verification result obtained by the image-data verification unit 303.

Then, the print control unit 103 of the printer 1 transmits the image number associated with the print number to be subjected to the next printing, to the setting apparatus 2. Thereafter, printing, reading, and inspection of an image are performed in the above-described manner. After printing of all images of the job is finished, the job is completed.

Now, operations of the above-described printing system will be described by using specific examples.

Table 1 illustrates an example of print conditions for a job executed by the printing system illustrated in FIG. 1.

TABLE 1

| Item | Print Conditions 1 | Print conditions 2 |
|---|---|---|
| Number of pages per set | 12 | 12 |
| Number of copies | 1 | 1 |
| Single-sided/double-sided setting | Single-sided | Double-sided |
| Set-by-set/page-by-page setting | Set-by-set | Set-by-set |
| Paper size | A4 | A4 |
| Paper orientation | Landscape | Landscape |
| Unit weight of paper(gsm) | 100 | 100 |
| Paper type | Ordinary | Ordinary |
| Productivity | Normal | Normal |

Table 1 illustrates two sets of print conditions. Specifically, in the print conditions 1, the number of pages per set is “12”; the number of copies is “1”; the single-sided/double-sided setting is “single-sided”; the set-by-set/page-by-page setting (collation-enable/disable setting) is “set-by-set”; the paper size is “A4”; the paper orientation is “landscape”; the unit weight of paper is “100 (gsm)”; the paper type is “ordinary sheet”; and the productivity is “normal mode”. Most of the print conditions 2 are the same as the print conditions 1 but differ from the print conditions 1 in that the single-sided/double-sided setting is “double-sided”.

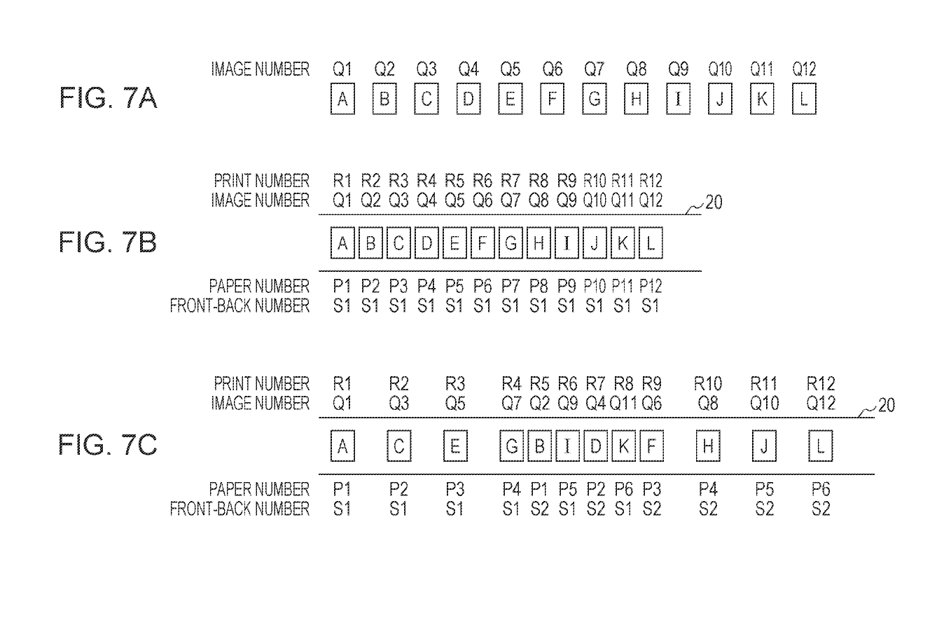

FIGS. 7A to 7C describe job scheduling under each of the sets of the print conditions 1 and 2 illustrated in Table 1. Here, FIG. 7A illustrates output image data created by the setting apparatus 2. FIG. 7B illustrates the printing order (scheduling) based on the print conditions 1 (in the single-sided mode). FIG. 7C illustrates the printing order (scheduling) based on the print conditions 2 (in the double-sided mode). Here, FIGS. 7B and 7C illustrate layouts of images on the intermediate transfer belt 20 that passes through the second transfer device 30. Here, the order in which images are arranged on the intermediate transfer belt 20 is the same as the order in which images are printed on the paper P.

In this example, as illustrated in Table 1 and FIG. 7A, one piece of output image data is constituted by pieces of original image data for twelve pages. The pieces of original image data include images “A” to “L” arranged in alphabetical order. Also, the pieces of original image data are assigned the image numbers Q1 to Q12 in order of page number (in alphabetical order in this example).

In the case of the print conditions 1 (the single-sided mode), as illustrated in FIG. 7B, the image numbers Q1 to Q12 are associated with print numbers R1 to R12, respectively, in order of page number in the scheduling data. This is because there is no need to turn over and transport the paper P (no need to use the third transport route R3) in the single-sided mode printing operation. In this case, corresponding images are printed in the order of the print numbers R1 to R12, on a first side S1 of twelve sheets of paper P assigned the paper numbers P1 to P12.

On the other hand, in the case of the print conditions (the double-sided mode), as illustrated in FIG. 7C, the image numbers Q1 to Q12 are associated with the print numbers R1 to R12 in the scheduling data, with the order of some of page numbers being switched. This is because it is necessary to turn over and transport the paper P (to use the third transport route R3) in the double-sided mode printing operation, and the order of printing is decided by taking the existence of the paper P that moves along the third transport route R3 into consideration in order to complete the printing operation within a short period of time (suppress a decrease in productivity). In this case, corresponding images are printed on the first side S1 and a second side S2 of six sheets of paper P assigned the paper numbers P1 and P6, in the order of the print numbers R1 to R12.

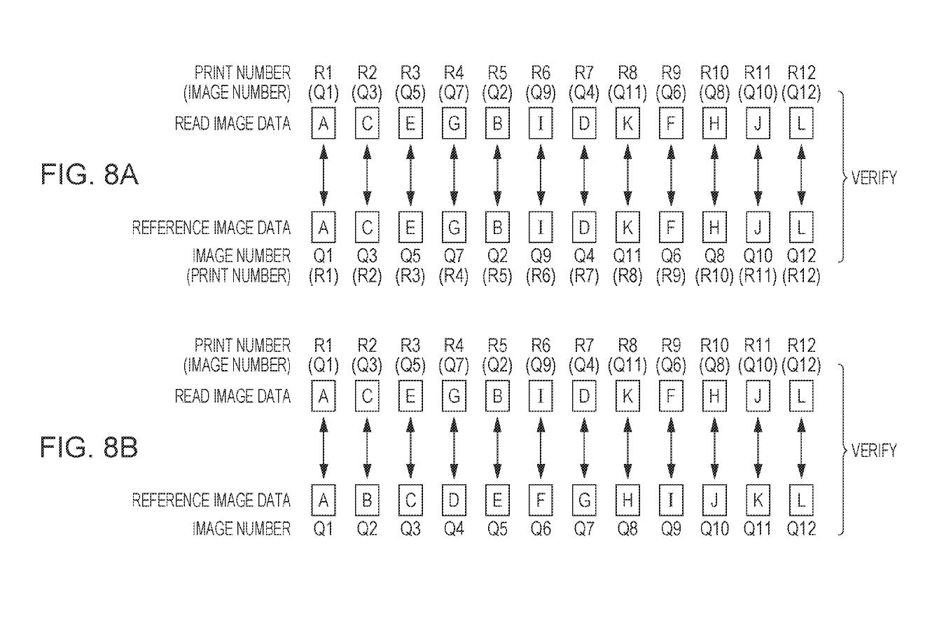

FIGS. 8A and 8B describe verification-based inspection performed on read image data that is obtained by reading an image having been printed under the printing conditions 2. Specifically, FIG. 8A illustrates the order in which verification-based inspection is performed using the inspecting apparatus 3 according to this exemplary embodiment. FIG. 8B illustrates the order in which verification-based inspection is performed using an inspecting apparatus according to the related art.

Pieces of read image data (for one page) are input to the inspecting apparatus 3 according to this exemplary embodiment in the order of the print numbers R1 to R12 which is decided on the basis of the scheduling data. This inspecting apparatus 3 prepares the reference image data (for one page) to be verified against this read image data (for one page), by using the output image data and the scheduling data.

Accordingly, as illustrated in FIG. 8A, in the image-data verification unit 303 according to this exemplary embodiment, the read image data and the reference image data that are associated with the same image number are compared and verified.

On the other hand, since the read image data and the reference image data are not associated with each other by using the image number, the inspecting apparatus according to the related art prepares the reference image data in the order of the image numbers Q1 to Q12 even if the pieces of read image data are input in the order of the print numbers R1 to R12 that is decided on the basis of the scheduling data. Accordingly, in this example, the read image data and the reference image data obtained from the different pieces of original image data are compared and verified except for the first page and the last page. As a result, the correctness determining unit 304 obtains a negative determination result (that there is an image defect) even for pages for which a positive determination result (that there is no image defect) is supposed to be obtained.

### Second Exemplary Embodiment

This exemplary embodiment is almost the same as the first exemplary embodiment. However, in this exemplary embodiment, the printer 1 supplies the image number to the inspecting apparatus 3 instead of the scheduling data, which is different from the first exemplary embodiment. In this exemplary embodiment, components that are similar to those described in the first exemplary embodiment are assigned the same references, and a detailed description thereof is omitted.

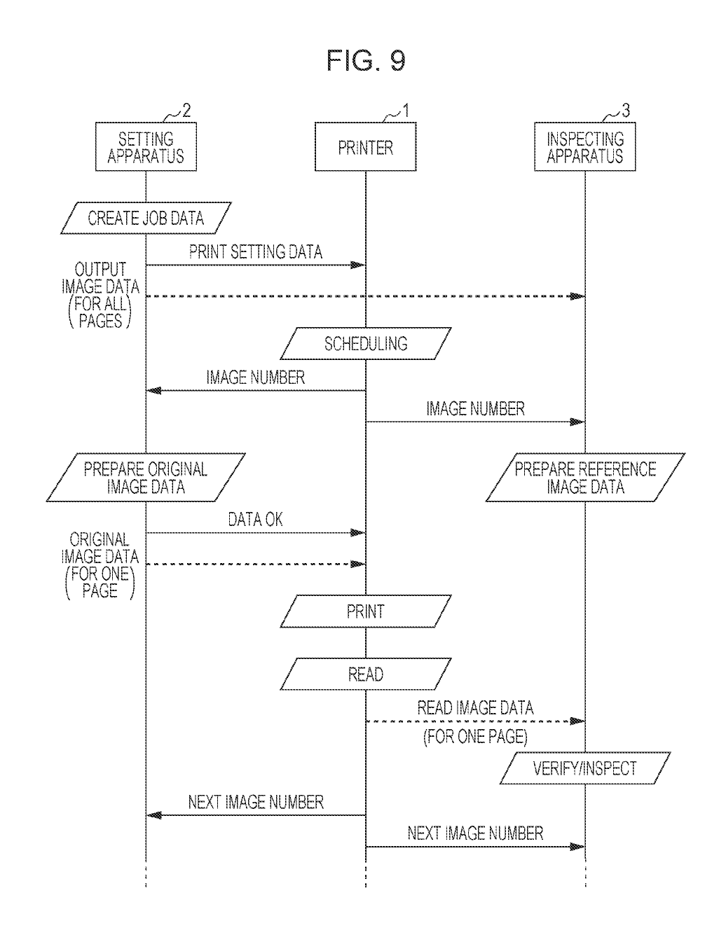

FIG. 9 is a sequence diagram for describing an operation of the printing system in the second exemplary embodiment. Operations of the apparatuses of the printing system and data exchanged between the apparatuses will be described below in accordance with FIG. 9.

Upon receipt of a job execution instruction via the UI 202 or the like, the setting apparatus 2 first creates job data.

Subsequently, the setting apparatus 2 transmits the print setting data stored in the I/O control unit 204 to the printer 1. In the printer 1, the printing-order deciding unit 102 receives the print setting data.

The setting apparatus 2 further transmits the output image data (for all pages) stored in the I/O control unit 204 to the inspecting apparatus 3. In the inspecting apparatus 3, the reference-image-data identifying unit 302 receives the output image data (for all pages).

Subsequently, the printing-order deciding unit 102 of the printer 1 creates scheduling data for the job on the basis of the received print setting data.

Then, on the basis of the scheduling data created by the printing-order deciding unit 102, the print control unit 103 of the printer 1 transmits the image number associated with the print number to be subjected to the next printing (i.e., the image number to be subjected to the next verification) to the setting apparatus 2 and the inspecting apparatus 3. In the setting apparatus 2, the I/O control unit 204 receives the image number, whereas in the inspecting apparatus 3, the reference-image-data identifying unit 302 receives the image number.

Then, the I/O control unit 204 of the setting apparatus 2 prepares the original image data (for one page) corresponding to the received image number, from the output image data (for all pages) stored therein.

On the other hand, the reference-image-data identifying unit 302 of the inspecting apparatus 3 prepares (identifies) reference image data (for one page) corresponding to the original image data (for one page) assigned the newly received image number, from the already received output image data (for all pages).

Subsequently, the I/O control unit 204 of the setting apparatus 2 transmits a notification (Data OK) indicating that preparation of the original image data (for one page) has been completed, to the printer 1. In the printer 1, the print control unit 103 receives this notification.

The I/O control unit 204 of the setting apparatus 2 then transmits the prepared original image data (for one page) to the printer 1. In the printer 1, the print control unit 103 receives this original image data (for one page).

Thereafter, the image forming section 10 of the printer 1 creates exposure data based on the received original image data, and prints an image corresponding to the original image data on paper P.

Subsequently, the image reading section 70 of the printer 1 reads the image having been printed by the image forming section 10. In response to the reading, the read control unit 104 of the printer 1 creates read image data (for one page).

Then, the read control unit 104 of the printer 1 transmits the created read image data (for one page) to the inspecting apparatus 3. The image-data verification unit 303 of the inspecting apparatus 3 receives this read image data (for one page).

Subsequently, the image-data verification unit 303 of the inspecting apparatus 3 verifies the read image data (for one page) transmitted from the printer 1 against the reference image data (for one page) identified by the reference-image-data identifying unit 302. Here, the reference image data (for one page) and the read image data (for one page) verified at this time are obtained from the original image data of the same page that constitutes the output image data. The correctness determining unit 304 of the inspecting apparatus 3 then determines whether or not the printed material serving as the original of the read image data is correct (whether or not there is a defect in the image), on the basis of a verification result obtained by the image-data verification unit 303.

Then, the print control unit 103 of the printer 1 transmits the image number associated with the print number to be subjected to the next printing, to the setting apparatus 2 and the inspecting apparatus 3. Thereafter, printing, reading, and inspection of an image are performed in the above-described manner. After printing of all images of the job is finished, the job is completed.

In this exemplary embodiment, data of the image number is transmitted to the setting apparatus 2 and the inspecting apparatus 3 every time before one image is printed and verified. Accordingly, even if paper jam of the paper P that occurs in the printer 1 during a job temporarily stops the job and the printing-order deciding unit 102 re-creates the scheduling data after restarting the job, the image number associated with the print number to be subjected to the next printing (i.e., the image number to be subjected to the next verification) is transmitted to the setting apparatus 2 and the inspecting apparatus 3 on the basis of the re-created scheduling data.

### Third Exemplary Embodiment

This exemplary embodiment is almost the same as the first exemplary embodiment. However, in this exemplary embodiment, the setting apparatus 2 supplies all pieces of original image data, i.e., the output image data, to the printer 1 in advance instead of supplying the pieces of original image data one by one, which is different from the first exemplary embodiment. In this exemplary embodiment, components that are similar to those described in the first exemplary embodiment are assigned the same references, and a detailed description thereof is omitted.

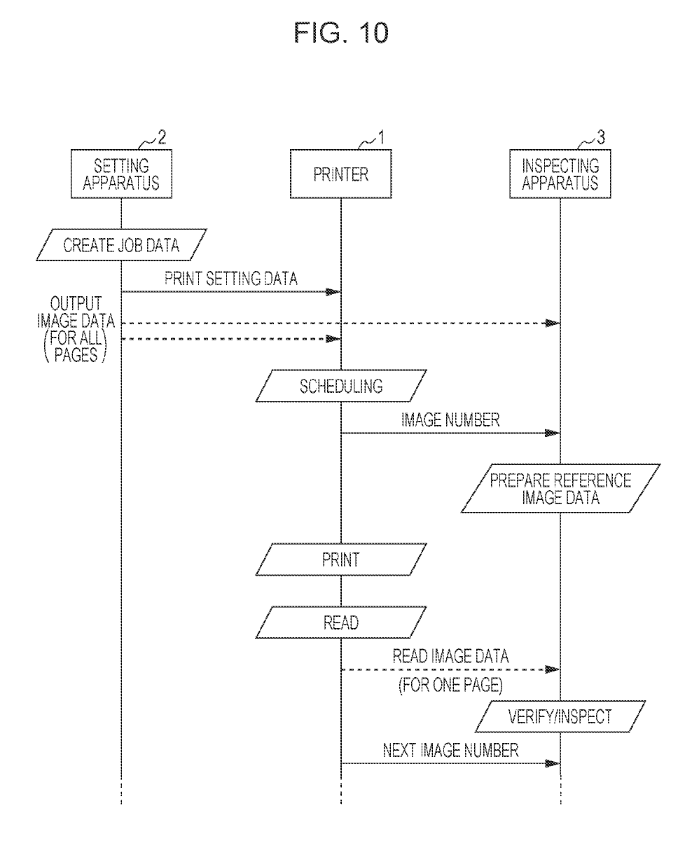

FIG. 10 is a sequence diagram for describing an operation of the printing system in the third exemplary embodiment. Operations of the apparatuses of the printing system and data exchanged between the apparatuses will be described below in accordance with FIG. 10.

Upon receipt of a job execution instruction via the UI 202 or the like, the setting apparatus 2 first creates job data.

Subsequently, the setting apparatus 2 transmits the print setting data stored in the I/O control unit 204 to the printer 1. In the printer 1, the printing-order deciding unit 102 receives the print setting data.

The setting apparatus 2 further transmits the output image data (for all pages) stored in the I/O control unit 204 to the inspecting apparatus 3 and the printer 1. In the inspecting apparatus 3, the reference-image-data identifying unit 302 receives the output image data (for all pages). In the printer 1, the print control unit 103 receives the output image data (for all pages).

Subsequently, the printing-order deciding unit 102 of the printer 1 creates scheduling data for the job on the basis of the received print setting data.

Then, on the basis of the scheduling data created by the printing-order deciding unit 102, the print control unit 103 of the printer 1 transmits the image number associated with the print number to be subjected to the next printing to the inspecting apparatus 3. In the inspecting apparatus 3, the reference-image-data identifying unit 302 receives the image number.

Thereafter, the reference-image-data identifying unit 302 of the inspecting apparatus 3 prepares (identifies) reference image data (for one page) corresponding to the original image data (for one page) assigned the newly received image number, from the already received output image data (for all pages).

Thereafter, the image forming section 10 of the printer 1 creates exposure data based on the original image data assigned the image number and selected in accordance with the scheduling data, and prints an image corresponding to the original image data on paper P.

Subsequently, the image reading section 70 of the printer 1 reads the image having been printed by the image forming section 10. In response to the reading, the read control unit 104 of the printer 1 creates read image data (for one page).

Then, the read control unit 104 of the printer 1 transmits the created read image data (for one page) to the inspecting apparatus 3. The image-data verification unit 303 of the inspecting apparatus 3 receives this read image data (for one page).

Subsequently, the image-data verification unit 303 of the inspecting apparatus 3 verifies the read image data (for one page) transmitted from the printer 1 against the reference image data (for one page) identified by the reference-image-data identifying unit 302. Here, the reference image data (for one page) and the read image data (for one page) verified at this time are obtained from the original image data of the same page that constitutes the output image data. The correctness determining unit 304 of the inspecting apparatus 3 then determines whether or not the printed material serving as the original of the read image data is correct (whether or not there is a defect in the image), on the basis of a verification result obtained by the image-data verification unit 303.

Then, the print control unit 103 of the printer 1 transmits the image number associated with the print number to be subjected to the next printing, to the inspecting apparatus 3. Thereafter, printing, reading, and inspection of an image are performed in the above-described manner. After printing of all images of the job is finished, the job is completed.

In this exemplary embodiment, the output image data (for all pages) is supplied to the printer 1 and the inspecting apparatus 3 from the setting apparatus 2 before the actual printing operation is started.

### Fourth Exemplary Embodiment

This exemplary embodiment is almost the same as the second exemplary embodiment. However, in this exemplary embodiment, the print control unit 103 of the printer 1 creates exposure data by performing screen conversion processing on original image data, which is different from the second exemplary embodiment. In this exemplary embodiment, components that are similar to those described in the first and second exemplary embodiments are assigned the same references, and a detailed description thereof is omitted.

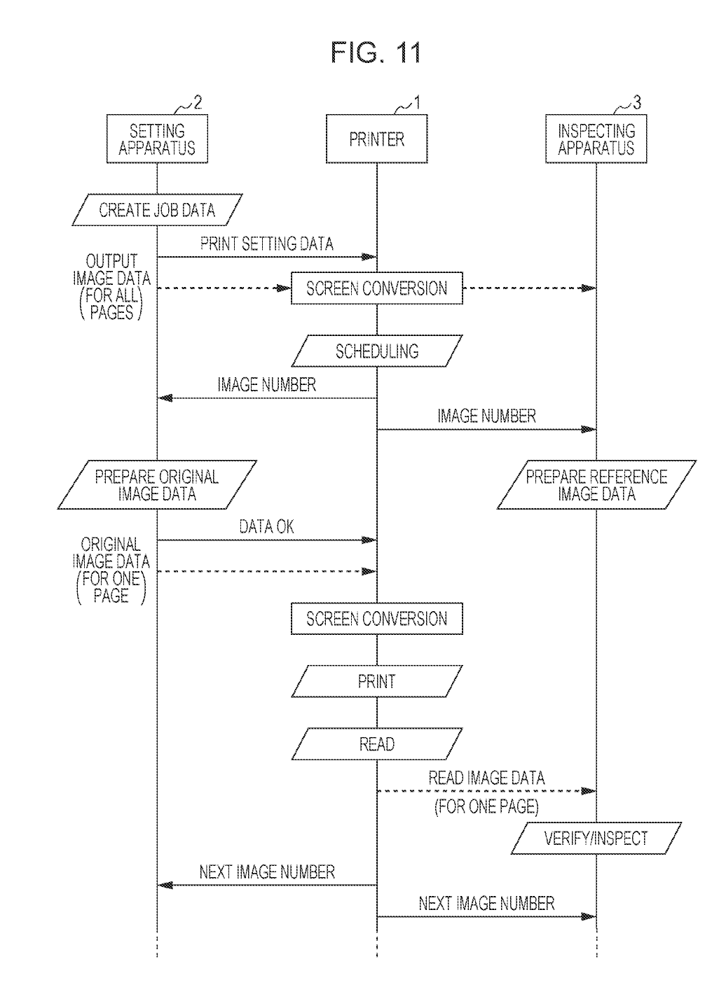

FIG. 11 is a sequence diagram for describing an operation of the printing system in the fourth exemplary embodiment. Operations of the apparatuses of the printing system and data exchanged between the apparatuses will be described below in accordance with FIG. 11.

Upon receipt of a job execution instruction via the UI 202 or the like, the setting apparatus 2 first creates job data.

Subsequently, the setting apparatus 2 transmits the print setting data stored in the I/O control unit 204 to the printer 1. In the printer 1, the printing-order deciding unit 102 receives the print setting data.

The setting apparatus 2 further transmits the output image data (for all pages) stored in the I/O control unit 204 to the printer 1. In the printer 1, the print control unit 103 receives the output image data (for all pages). The print control unit 103 performs screen conversion processing on this output image data (for all pages), and transmits the resulting output image data (for all pages) having undergone the screen conversion processing to the inspecting apparatus 3. In the inspecting apparatus 3, the reference-image-data identifying unit 302 receives the output image data (for all pages) having undergone the screen conversion processing.

Subsequently, the printing-order deciding unit 102 of the printer 1 creates scheduling data for the job on the basis of the received print setting data.

Then, on the basis of the scheduling data created by the printing-order deciding unit 102, the print control unit 103 of the printer 1 transmits the image number associated with the print number to be subjected to the next printing to the setting apparatus 2 and the inspecting apparatus 3. In the setting apparatus 2, the I/O control unit 204 receives the image number, whereas in the inspecting apparatus 3, the reference-image-data identifying unit 302 receives the image number.

Then, the I/O control unit 204 of the setting apparatus 2 prepares the original image data (for one page) corresponding to the received image number, from the output image data (for all pages) stored therein.

On the other hand, the reference-image-data identifying unit 302 of the inspecting apparatus 3 prepares (identifies) reference image data (for one page) corresponding to the original image data (for one page) assigned the newly received image number, from the already received output image data (for all pages).

Subsequently, the I/O control unit 204 of the setting apparatus 2 transmits a notification (Data OK) indicating that preparation of the original image data (for one page) has been completed, to the printer 1. In the printer 1, the print control unit 103 receives this notification.

The I/O control unit 204 of the setting apparatus 2 then transmits the prepared original image data (for one page) to the printer 1. In the printer 1, the print control unit 103 receives this original image data (for one page).

Thereafter, the image forming section 10 of the printer 1 creates exposure data by performing screen conversion processing on the received original image data, and prints an image corresponding to the original image data on paper P. The content (such as the screen frequency) of the screen conversion processing performed at this time is the same as the content of the above-described screen conversion processing performed on the output image data.

Subsequently, the image reading section 70 of the printer 1 reads the image having been printed by the image forming section 10. In response to the reading, the read control unit 104 of the printer 1 creates read image data (for one page).

Then, the read control unit 104 of the printer 1 transmits the created read image data (for one page) to the inspecting apparatus 3. The image-data verification unit 303 of the inspecting apparatus 3 receives this read image data (for one page).

Subsequently, the image-data verification unit 303 of the inspecting apparatus 3 verifies the read image data (for one page) transmitted from the printer 1 against the reference image data (for one page) identified by the reference-image-data identifying unit 302. Here, the reference image data (for one page) and the read image data (for one page) verified at this time are obtained from the original image data of the same page that constitutes the output image data. The correctness determining unit 304 of the inspecting apparatus 3 then determines whether or not the printed material serving as the original of the read image data is correct (whether or not there is a defect in the image), on the basis of a verification result obtained by the image-data verification unit 303.

Then, the print control unit 103 of the printer 1 transmits the image number associated with the print number to be subjected to the next printing, to the setting apparatus 2 and the inspecting apparatus 3. Thereafter, printing, reading, and inspection of an image are performed in the above-described manner. After printing of all images of the job is finished, the job is completed.

The original image data constituting the output image data generally does not undergo the screen conversion processing. Accordingly, for example, in a case where the printer 1 performs the screen conversion processing at a high resolution (a high screen frequency) during printing, the screen structure resulting from the screen conversion processing may be detected as an image defect when the reference image data and the read image data based on the original image data are verified in the inspecting apparatus 3.

### Fifth Exemplary Embodiment

This exemplary embodiment is almost the same as the first exemplary embodiment. However, in this exemplary embodiment, the setting apparatus 2 supplies the print setting data to the inspecting apparatus 3 as well as the printer 1 and the scheduling data is created also in the inspecting apparatus 3, which is different from the first exemplary embodiment. In this exemplary embodiment, components that are similar to those described in the first exemplary embodiment are assigned the same references, and a detailed description thereof is omitted.

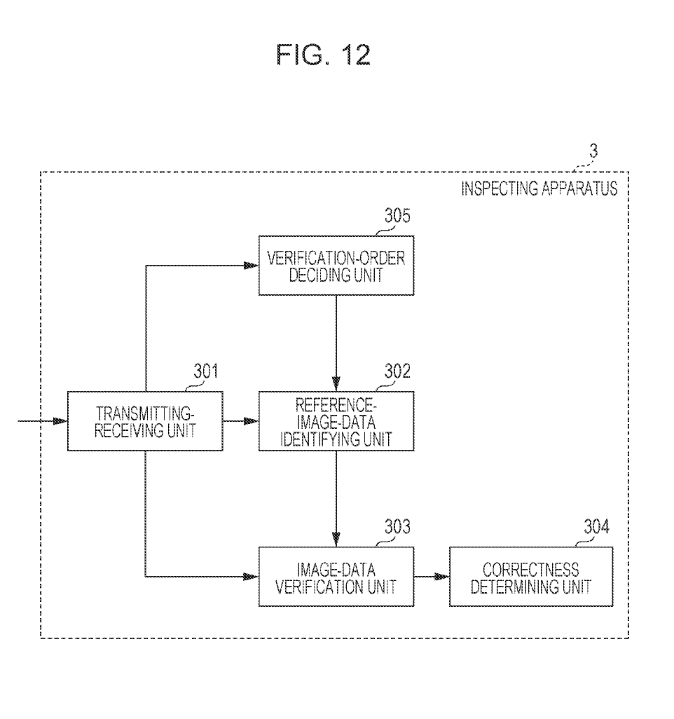

FIG. 12 is a block diagram illustrating a functional configuration of the inspecting apparatus 3 according to the fifth exemplary embodiment.

This inspecting apparatus 3 further includes a verification-order deciding unit 305 in addition to the transmitting-receiving unit 301, the reference-image-data identifying unit 302, the image-data verification unit 303, and the correctness determining unit 304.

The verification-order deciding unit 305 decides the verification order in which the inspection is performed by the image-data verification unit 303 (creates scheduling data), on the basis of the print setting data input from the setting apparatus 2 via the transmitting-receiving unit 301. The method used by the verification-order deciding unit 305 to decide the verification order is the same as the method used by the printing-order deciding unit 102 of the printer 1 to decide the printing order. Accordingly, the scheduling data of the printing order and the scheduling data of the verification order have the same content.

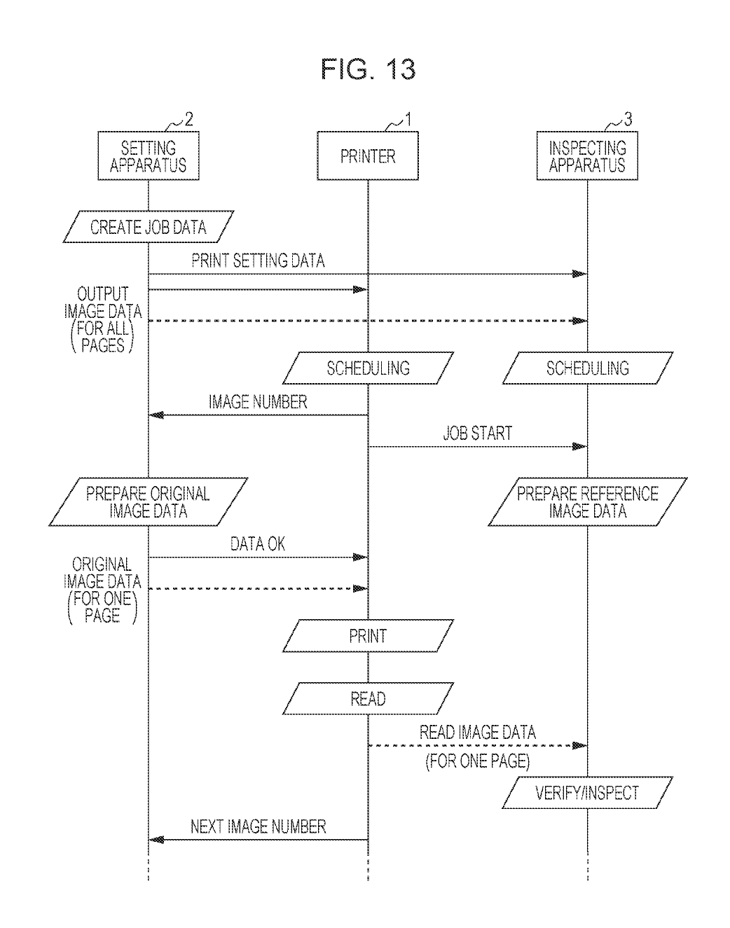

FIG. 13 is a sequence diagram for describing an operation of the printing system in the fifth exemplary embodiment. Operations of the apparatuses of the printing system and data exchanged between the apparatuses will be described below in accordance with FIG. 13.

Upon receipt of a job execution instruction via the UI 202 or the like, the setting apparatus 2 first creates job data.

Subsequently, the setting apparatus 2 transmits the print setting data stored in the I/O control unit 204 to the inspecting apparatus 3 and the printer 1. In the inspecting apparatus 3, the verification-order deciding unit 305 receives the print setting data. In the printer 1, the printing-order deciding unit 102 receives the print setting data.

The setting apparatus 2 further transmits the output image data (for all pages) stored in the I/O control unit 204 to the inspecting apparatus 3. In the inspecting apparatus 3, the reference-image-data identifying unit 302 receives the output image data (for all pages).

Subsequently, the printing-order deciding unit 102 of the printer 1 creates scheduling data for the job on the basis of the received print setting data.

Also, the verification-order deciding unit 305 of the inspecting apparatus 3 creates scheduling data for the job on the basis of the received print setting data.

Then, on the basis of the scheduling data created by the printing-order deciding unit 102, the print control unit 103 of the printer 1 transmits the image number associated with the print number to be subjected to the next printing to the setting apparatus 2. In the setting apparatus 2, the I/O control unit 204 receives the image number.

Then, the print control unit 103 of the printer 1 transmits a notification (Job Start) indicating that the job is about to be started, to the inspecting apparatus 3. In the inspecting apparatus 3, the reference-image-data identifying unit 302 receives this notification. Also, the reference-image-data identifying unit 302 of the inspecting apparatus 3 prepares (identifies) reference image data (for one page) corresponding to the original image data (for one page) to be printed next, on the basis of the already received output image data (for all pages) and the scheduling data created by the verification-order deciding unit 305.

On the other hand, the I/O control unit 204 of the setting apparatus 2 prepares the original image data (for one page) corresponding to the received image number, from the output image data (for all pages) stored therein.

Subsequently, the I/O control unit 204 of the setting apparatus 2 transmits a notification (Data OK) indicating that preparation of the original image data (for one page) has been completed, to the printer 1. In the printer 1, the print control unit 103 receives this notification.

The I/O control unit 204 of the setting apparatus 2 then transmits the prepared original image data (for one page) to the printer 1. In the printer 1, the print control unit 103 receives this original image data (for one page).

Thereafter, the image forming section 10 of the printer 1 creates exposure data based on the received original image data, and prints an image corresponding to the original image data on paper P.

Subsequently, the image reading section 70 of the printer 1 reads the image having been printed by the image forming section 10. In response to the reading, the read control unit 104 of the printer 1 creates read image data (for one page).

Then, the read control unit 104 of the printer 1 transmits the created read image data (for one page) to the inspecting apparatus 3. The image-data verification unit 303 of the inspecting apparatus 3 receives this read image data (for one page).

Subsequently, the image-data verification unit 303 of the inspecting apparatus 3 verifies the read image data (for one page) transmitted from the printer 1 against the reference image data (for one page) identified by the reference-image-data identifying unit 302. Here, the reference image data (for one page) and the read image data (for one page) verified at this time are obtained from the original image data of the same page that constitutes the output image data. The correctness determining unit 304 of the inspecting apparatus 3 then determines whether or not the printed material serving as the original of the read image data is correct (whether or not there is a defect in the image), on the basis of a verification result obtained by the image-data verification unit 303.

Then, the print control unit 103 of the printer 1 transmits the image number associated with the print number to be subjected to the next printing, to the setting apparatus 2. Thereafter, printing, reading, and inspection of an image are performed in the above-described manner. After printing of all images of the job is finished, the job is completed.

In the first to fifth exemplary embodiments, the reference image data is created on the basis of the original image data that constitutes the output image data. However, the method for creating the reference image data is not limited to this one. For example, an image based on the output image data may be printed on the paper P in advance by using the printer 1. The reference image data may be created on the basis of read image data obtained by reading the resulting printed material with the image reading section 70. In this case, however, the printed material free from image defects is desirably used as the original of the reference image data.

Additionally, in the first to fifth exemplary embodiments, the read image data and the reference image data are verified for all pages in the order of print number. However, for example, when plural pieces of original image data include a blank page, verification of the read image data and the reference image data for this blank page may be omitted.

Furthermore, in the first to fifth exemplary embodiments, the setting apparatus 2 and the inspecting apparatus 3 are configured as separate computers. However, the configuration is not limited this example, and the setting apparatus 2 and the inspecting apparatus 3 may be realized by using a single computer. Additionally, in the first to fifth exemplary embodiments, the printer 1, the setting apparatus 2, and the inspecting apparatus 3 are configured as separate apparatuses. However, the configuration is not limited to this example. The inspecting apparatus 3 may be included in the printer 1 or the setting apparatus 2 may be included in the printer 1.

Moreover, in the first to fifth exemplary embodiments, the image forming section 10 of the printer 1 adopts the electrophotography. However, the printing method is not limited to this method, and the inkjet method or the electrostatic recording method may be adopted.

In the first exemplary embodiment, the example has been described in which the image number and the print number differ in the double-sided mode. The case in which such a relationship occurs is not limited to the double-sided mode. For example, when “page-by-page” is selected in the set-by-set/page-by-page setting (collation-enable/disable setting) in a case where plural sets are printed on the basis of the output image data, the image number and the print number also differ. Also, the image number and the print number differ in reverse printing in which printing is performed in the opposite order of the order of page number, unlike correct-order printing in which printing is performed in order of page number.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A printing system comprising:
a deciding unit that decides, by using output image data that includes pieces of original image data corresponding to a plurality of pages and by using setting data associated with the output image data, a printing order in which the plurality of pages of the output image data are to be printed;
a printing unit that respectively prints images of the plurality of pages on recording media by using the output image data, in accordance with the printing order decided by the deciding unit;
a reading unit that reads, in accordance with the printing order decided by the deciding unit, the images of the plurality of pages having been printed by the printing unit on the recording media to obtain pieces of read image data corresponding to the plurality of pages;
an identifying unit that identifies pieces of reference image data corresponding to the plurality of pages of the output image data, in accordance with the printing order decided by the deciding unit; and
a verification unit that verifies, for each page, the piece of read image data of the page against the corresponding piece of reference image data identified by the identifying unit.

2. The printing system according to claim 1, wherein the setting data is data regarding any of
the number of copies to be printed,
a single-sided-or-double-sided setting indicating whether the images of the plurality of pages are to be printed on one side or both sides of the recording media,
a collation-enable-or-disable setting indicating, when a plurality of sets of pages, each of the plurality sets of pages including the plurality of pages, are to be printed, whether the images of the plurality of pages are to be printed on the recording media on a set-by-set basis or a page-by-page basis,
the size of the recording media,
the orientation of the recording media,
the unit weight of the recording media, and
the type of the recording media.

3. The printing system according to claim 1, wherein the identifying unit identifies, for each page, a piece of original image data corresponding to the page from the output image data in accordance with the printing order, and creates a piece of reference image data corresponding to the page on the basis of the identified piece of original image data.

4. The printing system according to claim 1, wherein the printing unit prints the images of the plurality of pages on the recording media without using a printing plate.

5. An image inspecting apparatus comprising:
an output-image-data acquiring unit that acquires output image data that includes pieces of original image data corresponding to a plurality of pages;
a printing-order acquiring unit that acquires a printing order in which the plurality of pages of the output image data are to be printed, the printing order having been decided by using the output image data and setting data associated with the output image data;
an identifying unit that identifies pieces of reference image data corresponding to the plurality of pages of the output image data, in accordance with the printing order acquired by the printing-order acquiring unit; and
a verification unit that verifies, for each page, a piece of read image data of the page obtained by reading an image of the page having been printed on a recording medium in accordance with the printing order, against the corresponding piece of reference image data identified by the identifying unit.

6. The image inspecting apparatus according to claim 5, wherein the identifying unit identifies, for each page, a piece of original image data corresponding to the page from the output image data in accordance with the printing order, and creates a piece of reference image data corresponding to the page on the basis of the identified piece of original image data.

7. A printing system comprising:
a deciding unit that decides, by using output image data that includes pieces of original image data corresponding to a plurality of pages and by using setting data associated with the output image data, a printing order in which the plurality of pages of the output image data are to be printed, the printing order being different from an order of page numbers of the plurality of pages of the output image data;
a printing unit that respectively prints images of the plurality of pages on recording media by using the output image data, in accordance with the printing order decided by the deciding unit;
a reading unit that reads, in accordance with the printing order decided by the deciding unit, the images of the plurality of pages having been printed by the printing unit on the recording media to obtain pieces of read image data corresponding to the plurality of pages;
an identifying unit that identifies, for each page, a piece of original image data corresponding to the page from the output image data in accordance with the printing order, and creates a piece of reference image data corresponding to the page on the basis of the identified piece of original image data; and
a verification unit that verifies, for each page, the piece of read image data of the page against the corresponding piece of reference image data identified by the identifying unit.

8. The printing system according to claim 7, wherein the setting data is data regarding any of
the number of copies to be printed,
a single-sided-or-double-sided setting indicating whether the images of the plurality of pages are to be printed on one side or both sides of the recording media,
a collation-enable-or-disable setting indicating, when a plurality of sets of pages, each of the plurality sets of pages including the plurality of pages, are to be printed, whether the images of the plurality of pages are to be printed on the recording media on a set-by-set basis or a page-by-page basis,
the size of the recording media,
the orientation of the recording media,
the unit weight of the recording media, and
the type of the recording media.

9. A printing method comprising:
deciding, by using output image data that includes pieces of original image data corresponding to a plurality of pages and by using setting data associated with the output image data, a printing order in which the plurality of pages of the output image data are to be printed;
respectively printing images of the plurality of pages on recording media by using the output image data, in accordance with the decided printing order;
reading, in accordance with the decided printing order, the images of the plurality of pages having been printed on the recording media to obtain pieces of read image data corresponding to the plurality of pages;
identifying pieces of reference image data corresponding to the plurality of pages of the output image data, in accordance with the decided printing order; and
verifying, for each page, the piece of read image data of the page against the corresponding identified piece of reference image data.
